(19) United States
(12) Patent Application Publication
(10) Pub. No.: US 2024/0006922 A1
(43) Pub. Date: Jan. 4, 2024

(54) WIRELESS POWER REGULATION AND CONTROL USING A RESONANT INTERMEDIATE COIL

(71) Applicant: Auckland UniServices Limited, Auckland (NZ)

(72) Inventors: Grant Anthony COVIC, Auckland (NZ); Chang-Yu HUANG, Auckland (NZ); Ahmed BILAL, Auckland (NZ); Duleepa Jayanath THRIMAWITHANA, Auckland (NZ)

(21) Appl. No.: 18/351,943

(22) Filed: Jul. 13, 2023

Related U.S. Application Data
(63) Continuation of application No. PCT/IB2022/050491, filed on Jan. 20, 2022.

(30) Foreign Application Priority Data
Jan. 20, 2021 (NZ) 772139

(51) Int. Cl. H02J 50/12

(52) U.S. Cl. CPC H02J 50/12

(57) ABSTRACT

A method and apparatus for controlling an intermediate resonant circuit in a wireless power or IPT system includes regulating a secondary with which the intermediate circuit is magnetically coupled so as to control the VA in the intermediate resonant circuit and to control magnetic leakage fields.

### FIELD OF THE INVENTION

This disclosure relates to inductive or wireless power transfer, and to the control or regulation of power transfer in inductive or wireless power transfer systems, including systems which have an intermediate resonant coupler.

### BACKGROUND

Inductive power transfer (IPT), also frequently referred to as wireless power transfer (WPT), is a method of wireless charging using magnetic fields without any physical connections. The ability to wirelessly charge has led to its adoption in a wide range of applications including charging of biomedical implants, automated guided vehicles, electric vehicles and underwater applications, amongst many others. Typical IPT systems use two resonant coils to couple power. The coils each comprise part of a magnetic structure, often referred to as a pad. The pad which produces the magnetic field is usually referred to as the primary pad, and the coil of the primary pad is the primary coil. The pad that couples with the magnetic field to receive power is usually referred to as the secondary, or pick-up pad, and the coil of that pad is the secondary or pick-up coil. In some systems an intermediate structure having an intermediate coil is provided i.e. a structure with a coil located between the primary and the secondary structures. The intermediate coil may include local regulation means, to shut off power in an intermediate structure. However, regulating high power transfer over large distances using an intermediate coil without any local regulation is more complex. This disclosure proposes means to achieve this while managing the Volt amps (VA) in the intermediate coil while also considering the implications of flux leakage.

For IPT applications, one of the factors that determines the power transfer capability of a system is the magnetic pad structure. The size and design of the magnetic pad structures can determine the air gap across which power can be transmitted and can also help limit the leakage magnetic fields (B_{leakage}). To use these pads commercially, it needs to be economical and meet the rules and regulations for the country. In the example of wireless EV charging applications, standards bodies such as SAE consider charging specifications for vehicles with power levels up to 10 kW and with typical ground clearances between 100 to 250 mm. Installing this wireless EV charging infrastructure is an expensive undertaking, so it is crucial that when wireless chargers are installed in a road, they can supply power to a range of different vehicles.

Future opportunities for wireless charging need to embrace charging opportunities for electric trucks and even electric planes or air-mobility vehicles when stationary. In these applications the ground clearances, i.e., the air gap, between the vehicle and a road or ground surface are considerably larger. As is shown below, simply scaling known charging systems to meet this larger gap clearance is not necessarily a suitable solution.

Two simple parameters which can be used as a base of comparison is the volt-amp effort required by the primary pad and the magnetic leakage fields produced.

With increase in air gap, the power transfer ability decreases exponentially while increasing the leakage fields. Various methods are available to increase the power delivered to the secondary pad at large air gaps. The simplest method is to increase the volt-amp (VA) ratings of the primary pad by increasing the primary pad size (L₁), primary current (I₁) or the operating frequency (ω). However, the main problem of increasing the VA ratings of the primary pad at high air gaps is that the cost of the power electronics increases along with the magnetic leakage fields. These leakage fields need to be under 27 uT wherever humans may be present, to meet the International Commission on Non-Ionizing Radiation Protection (ICNRIP) guidelines. Having higher leakage fields can induce eddy currents into metallic objects and can be a significant problem for people wearing pacemakers or who have metallic implants in the body.

One method to mitigate this includes adding an active suspension system to lower the entire vehicle, but these can be expensive to install in applications where this is possible, and are not possible with all applications given the robustness of the systems is now reliant on a mechanical apparatus with added increase in system cost and weight. This also adds significant expense to the secondary magnetics and electronics due to cables, and cooling mechanisms.

For applications where the primary needs to be buried under the ground, there is equally a possibility for placing such an intermediate resonator flush with the surface of the road to “bounce” the field to the vehicle.

While the general concept of using a resonant intermediate coil is known, there is the problem of determining the appropriate position of such a device and the required tuning and control features in the system to ensure it is possible to manage the volt-amps in the intermediate resonant coil, while regulating power and constraining leakage in surrounding regions of interest. Power flow in wireless power systems occurs from the primary to the secondary, hence systems to date have simply assumed that the regulation for the intermediate circuit is managed by the primary.

### Object

It is an object of this disclosure to provide a means to achieve control and/or power regulation in a wireless power system having an intermediate structure.

### SUMMARY

In one aspect the present disclosure provides a method of controlling an intermediate resonant circuit in a wireless power or IPT system, the method comprising regulating a secondary with which the intermediate circuit is magnetically coupled.

The method may further include controlling the primary, in particular the VA of the primary.

The method may therefore include controlling the VA of the primary, secondary and intermediate structure while also regulating the power supplied by the secondary.

Regulation of the output may comprise regulation of the secondary to control a load seen looking into the secondary.

In an embodiment the secondary comprises a series tuned resonant circuit.

In an embodiment the primary comprises a current sourced primary. The primary may comprise a parallel tuned resonant circuit.

In an embodiment the primary comprises a voltage sourced primary. The primary may comprise a series tuned resonant circuit.

In another aspect the present disclosure provides a method leakage field control for an IPT system having an intermediate coupling structure, the method comprising regulating a secondary to thereby regulate leakage field from the intermediate coupling structure.

The method for controlling leakage field from the intermediate coupling structure includes controlling the VA in the intermediate coupling structure.

The method may further include controlling the primary, in particular the VA of the primary.

The method may therefore include controlling the VA of the primary, secondary and intermediate structure while also regulating the power supplied by the secondary.

The method may include regulation of the secondary to control a load seen looking into the secondary.

In an embodiment the secondary comprises a series tuned resonant circuit.

In an embodiment the primary comprises a current sourced primary. The primary may comprise a parallel tuned resonant circuit.

In an embodiment the primary comprises a voltage sourced primary. The primary may comprise a series tuned resonant circuit.

In another aspect the disclosure provides a wireless or IPT secondary comprising a resonant circuit and a power regulation circuit operable to control or regulate the secondary, wherein the regulation circuit is operable to control a load of the secondary to thereby control a VA load in an intermediate resonant circuit with which the secondary may be magnetically coupled.

The regulation circuit may comprise regulation of the secondary to control a load seen looking into the secondary. The regulation circuit may control the power supplied by or made available by the secondary.

In an embodiment the secondary comprises a series tuned resonant circuit.

In another aspect the disclosure provides a wireless or IPT secondary comprising a resonant circuit and a power regulation circuit operable to control or regulate the secondary, wherein the regulation circuit is operable to control a leakage field in an intermediate coupling structure with which the secondary may be magnetically coupled.

The leakage field of the intermediate coupling structure may be controlled by control of the VA in the intermediate coupling structure. The VA in the intermediate coupling structure may be controlled by the power regulation circuit.

The power regulation circuit may comprise a switching circuit.

The power regulation circuit may comprise one or more of: a DC/DC converter; a bridge circuit; a boost converter; a buck/boost converter; an AC switching circuit.

The AC switching circuit may be a shorting circuit or a synchronised switching circuit.

The bridge circuit may comprise an H bridge circuit.

In another aspect the present disclosure provides a method of controlling an intermediate resonant circuit in a wireless power or IPT system, the method comprising determining a physical distance between a coil of the intermediate resonant circuit a secondary with which the intermediate resonant circuit is magnetically coupled.

The method may further comprise regulating an output of the secondary.

Determining the physical distance may comprise selecting a fixed distance to thereby control a VA relationship between the secondary and the intermediate resonant circuit.

Determining the physical distance may comprise varying the distance to thereby control a VA relationship between the secondary and the intermediate resonant circuit.

The method may further include controlling the primary, in particular the VA of the primary.

The method may therefore include controlling the VA of the primary, secondary and intermediate structure while also regulating the power supplied by the secondary.

Regulation of the output may comprise regulation of the secondary to control a load seen looking into the secondary.

In an embodiment the secondary comprises a series tuned resonant circuit.

In an embodiment the primary comprises a current sourced primary. The primary may comprise a parallel tuned resonant circuit.

In another aspect the present disclosure provides a method leakage field control for an IPT system having an intermediate coupling structure, the method comprising determining a physical distance between a coil of the intermediate coupling structure and a secondary with which the intermediate coupling structure is magnetically coupled.

The method may further comprise regulating a secondary to thereby regulate leakage field from the intermediate coupling structure.

Determining the physical distance may comprise selecting a fixed distance to thereby control a VA relationship between the secondary and the intermediate resonant circuit.

Determining the physical distance may comprise varying the distance to thereby control a VA relationship between the secondary and the intermediate resonant circuit.

The method for controlling leakage field from the intermediate coupling structure includes controlling the VA in the intermediate coupling structure.

The method may further include controlling the primary, in particular the VA of the primary.

The method may therefore include controlling the VA of the primary, secondary and intermediate structure while also regulating the power supplied by the secondary.

The method may include regulation of the secondary to control a load seen looking into the secondary.

In an embodiment the secondary comprises a series tuned resonant circuit.

In an embodiment the primary comprises a current sourced primary. The primary may comprise a parallel tuned resonant circuit.

In another aspect the disclosure provides a wireless or IPT secondary comprising a resonant circuit and a distance selection means to control a VA load in an intermediate resonant circuit with which the secondary may be magnetically coupled.

The secondary may comprise a regulation circuit to control a load seen looking into the secondary. The regulation circuit may control the power supplied by or made available by the secondary.

In an embodiment the secondary comprises a series tuned resonant circuit.

In another aspect the disclosure provides a wireless or IPT secondary comprising a resonant circuit and a power regulation circuit operable to control or regulate the secondary, wherein the regulation circuit is operable to control a leakage field in an intermediate coupling structure with which the secondary may be magnetically coupled.

The leakage field of the intermediate coupling structure may be controlled by control of the VA in the intermediate coupling structure. The VA in the intermediate coupling structure may be controlled by the power regulation circuit.

The power regulation circuit may comprise a switching circuit.

The power regulation circuit may comprise one or more of: a DC/DC converter; a bridge circuit; a boost converter; a buck/boost converter; an AC switching circuit.

The AC switching circuit may be a shorting circuit or a synchronised switching circuit.

The bridge circuit may comprise an H bridge circuit.

In another aspect the disclosure provides a wireless primary having a distance selection means to select a distance between the primary and a coil of an intermediate resonant circuit, wherein the distance selection means controls a leakage field produced by the intermediate resonant circuit.

The primary may be voltage sourced. The primary may comprise a series tuned resonant circuit.

In another aspect the disclosure provides a wireless primary having a distance selection means to select a distance between the primary and a coil of an intermediate resonant circuit, wherein the distance selection means controls the VA in the intermediate resonant circuit.

The primary may be voltage sourced. The primary may comprise a series tuned resonant circuit.

In another aspect the disclosure provides an IPT or wireless primary structure which is voltage sourced and which has an intermediate magnetic structure at a selected distance from the coil of the primary structure whereby the selected distance is selected for control of the VA in the intermediate structure.

In another aspect the disclosure provides an IPT or wireless secondary structure which is operable to be supplied from a current sourced primary structure and which has an intermediate magnetic structure at a selected distance from the coil of the secondary structure whereby the selected distance is selected for control of the VA in the intermediate structure. Further aspects will be apparent from the following description.

### DRAWING DESCRIPTION

FIG. 1 is a circuit schematic of typical two coil IPT system with an example parallel tuning on the secondary.

FIG. 2 shows a model of a three-coil system with the third coil comprising an intermediate resonant pad.

FIG. 3 is a three-coil system using either a ferrite-less single or multi-coil intermediate tuned to resonance.

FIG. 4 is a graph of power against displacement.

FIG. 5 is an example leakage fields of rectangular magnetic topology with all three pads centered based on displacement of the intermediate.

FIG. 6 is an example leakage fields of rectangular magnetic topology with the intermediate and secondary pads offset from the primary pad, and varying displacement of the intermediate.

FIG. 7 is an intermediate pad placed midway between the primary and secondary, and sized identical to the primary.

FIG. 8 is a graph of leakage flux density against displacement.

FIG. 9 is a comparative volt-amp effort required to deliver 10 kW with increasing separation of the GA_Coil and VA_Coil, against the volt-amp effort of a three coil system at 411 mm separation and intermediate at 220 mm z-spacing.

FIG. 10 is leakage fields with two-coil at varying separation versus the three-coil system at 411 mm spacing and intermediate placed at 220 mm.

FIG. 11 is a regulation of a three-coil system with 10 kW output.

FIG. 12 is examples of secondary control regulation options for a current sourced primary and series tuned secondary.

FIG. 13 is a diagrammatic side elevation of a primary, intermediate and secondary with a control arrangement to control the position of the intermediate relative to the secondary.

### DESCRIPTION OF ONE OR MORE EXAMPLES OR EMBODIMENTS

Although this disclosure refers to electric vehicle applications as examples, it will be understood by those skilled in the art that the disclosure is also applicable to many other wireless power transfer applications, including without limitation low power applications such as charging or powering electronic devices such as cell phones, notebooks, laptops and sensors.

### A Two-Coil IPT System

Inductive power transfer (IPT) is a method of transferring power across an air gap using the fundamental laws of electromagnetism as defined by Faraday's and Ampere's laws. When an alternating current passes through the primary conductor (typically comprising a coil), an alternating electromagnetic field induces a voltage in the secondary coil. Throughout this description, the subscript 1 and 2 will correspond to the primary (the ground side in the context of vehicle charging) and secondary (the vehicle in the context of vehicle charging) pad respectively, i.e. I1 and I2 correspond to the primary current and secondary coil current respectively. This disclosure may refer also to primary and secondary magnetic structures. These are structures that include coils and are sometimes referred to as pads. In the drawings, the reference numerals 1, 2, and 3 are used to refer generally to the primary, secondary and intermediate parts respectively. It will also be understood that a “pick-up” is an IPT secondary apparatus or coil. Although aspects of the disclosure are explained with reference to a full system it will be understood that a primary, secondary or intermediate device may be provided that can be used with an existing system or parts of an existing system.

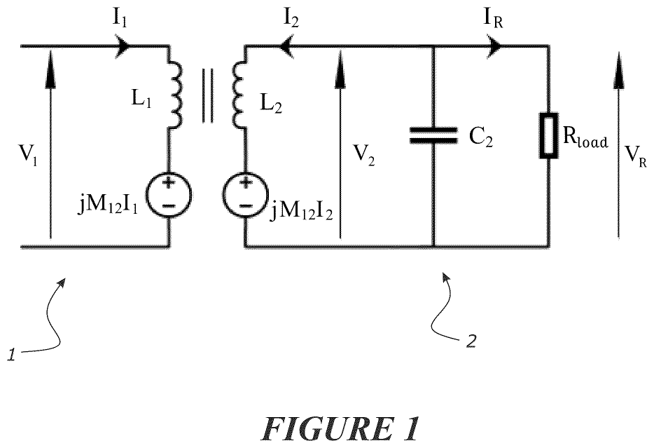

Typically, in an IPT system, the secondary comprises a rectifier and a DC/DC converter to maintain the constant current/constant voltage (CC/CV) charging characteristics required for charging a battery. This means the equivalent load changes at different stages of the charging cycle. Such an example system is shown in simple form for a parallel tuned secondary 2 in FIG. 1.

To simplify the following analysis, it is assumed an equivalent resistive load (R_{load}) is used when delivering 10 kW at 50 A and that the primary side provides a constant current to the primary pad. Therefore, using the mutual inductance model and Kirchhoff's law, the voltage across the primary and secondary pad can be expressed by equation (1). Here, Z₁ and Z₂ represents the impedance seen across the primary and secondary side, while, r₁ and r₂ represent the resistive losses in the primary and secondary pad.

$$[ \begin{matrix}{V}_{1} \\ 0\end{matrix} ] = [ \begin{matrix}{Z}_{1} & j ω {M}_{12} \\ j ω {M}_{12} & {Z}_{2}\end{matrix} ] [ \begin{matrix}{I}_{1} \\ {I}_{2}\end{matrix} ] \qquad ( 1 )$$

$$Where ,$$

$${Z}_{1} = j ω {L}_{1} + {r}_{1}$$

$${Z}_{2} = j ω {L}_{2} + {r}_{2} + \frac{1}{j ω {C}_{2} + {R}_{load}}$$

To increase the power transfer capability of IPT systems, the IPT pads are compensated with tuning capacitors. This helps reduce the impedance of the inductive coils and allows the circuit to operate at resonance which increases the power transfer efficiency. Depending on the way the capacitor is connected, i.e. series or parallel, across the secondary pad, the secondary side can exhibit current source or voltage source characteristics.

The open circuit voltage (Voc) and short circuit current (Isc) of the secondary coil is well known. Here, the L₁, V₁ and I₁ represent the primary side inductance, voltage and current respectively, while, L₂, V₂ and I₂ represents the secondary side inductance, voltage and current respectively. ω is the operating resonant angular frequency of the IPT system. M₁₂ is the mutual inductance between primary and secondary side and can be determined as shown before, where, k₁₂ represents the magnetic coupling between the primary and secondary coupling.

$${V}_{o c} = j ω {M}_{12} {I}_{1}$$

$${I}_{sc} = \frac{{M}_{12}}{{L}_{2}} {I}_{1}$$

$${M}_{12} = {k}_{12} \sqrt{{L}_{1} {L}_{2}}$$

The power (P_{load}) delivered to the secondary load (R_{load}) can be expressed by the following, where Q2 represents the secondary loaded quality factor of the parallel LC circuit shown in FIG. 1. Assuming a fixed operating frequency, the tuning capacitors can be easily calculated. The Volt-amps of the primary and secondary inductances are also expressed using S₁ and S₂.

$$ω = \frac{1}{\sqrt{L C}}$$

$${Q}_{2} = \frac{{R}_{2}}{ω {L}_{2}}$$

$${P}_{load} = {Q}_{2} {V}_{o c} {I}_{sc} = {Q}_{2} ω {L}_{1} {I}_{1}^{2} {k}_{12}^{2}$$

$${S}_{1} = \vert {V}_{1} \vert \vert {I}_{1} \vert$$

$${S}_{2} = \vert {V}_{2} \vert \vert {I}_{2} \vert$$

### A Possible Three Coil Wireless Power Transfer System

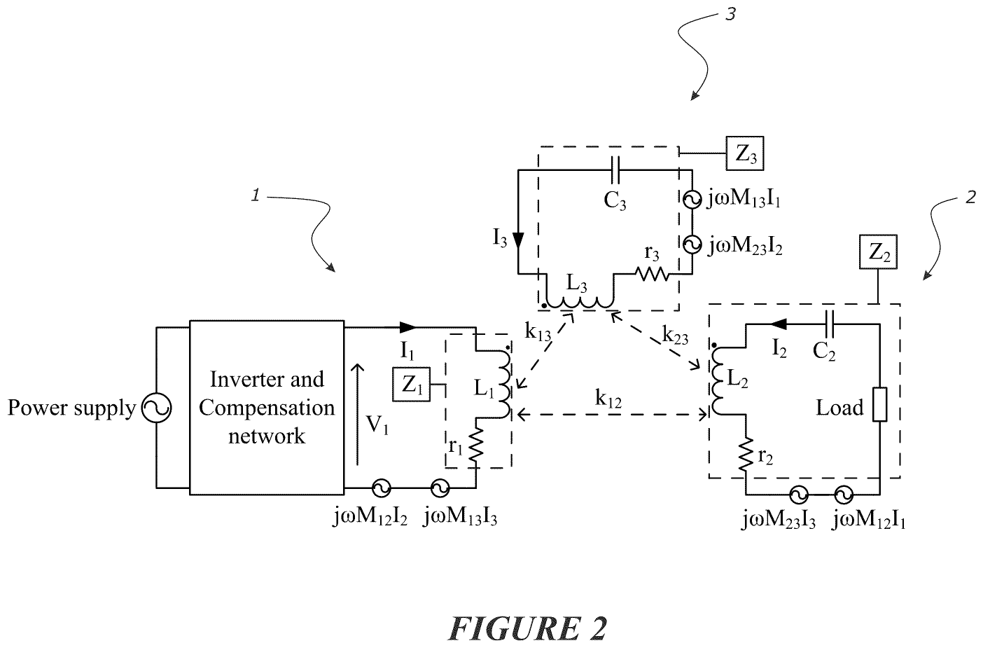

FIG. 2 shows a known model of a three coil IPT system with an intermediate pad. Numerous research papers have defined the basic mathematical models for such multi-coil IPT systems but the majority consider power regulation and control only from the primary given the secondary is simply a rectified load, and those which do not, use the intermediate structure in line with the primary or secondary magnetics rather than positioned in the space between these structures. Most of the research papers simply ignore the coupling between the primary and secondary pad (k₁₂) and the resistive losses of the pads given k₁₂ can be as low as 0.03 at large separation and, when Litz wires are used for the coils within the magnetic pads, the pad resistive losses can be small (particularly if ferrite and aluminium are not used in the pads), compared to the load connected.

In FIG. 2, the primary circuit components carry subscript 1, the secondary circuit subscript 2, and the intermediate circuit subscript 3.

Using the mutual inductance model and KVL theory similar to the two-coil system, we propose that the following simplified equations can be written, where here the intermediate coil has the subscript 3, while subscript 1 refers to the primary and subscript 2 refers to the secondary with load attached.

V₁=Z₁I₁+jωM₁₂I₂+jωM₁₃I₃

0=jωM₁₂I₁+Z₂I₂+jωM₂₃I₃

0=jωM₁₃I₁+jωM₂₃I₂+Z₃I₃

To determine the effort required by the primary power supply to provide power to the secondary, the currents in the different coils can be determined in terms of the primary power supply current, as shown below.

$$\frac{{I}_{3}}{{I}_{1}} = - \frac{( {ω}^{2} {M}_{12} {M}_{23} + j ω {M}_{13} {Z}_{2} )}{{ω}^{2} {M}_{23}^{2} + {Z}_{2} {Z}_{3}}$$

$$\frac{{I}_{2}}{{I}_{1}} = - \frac{( {ω}^{2} {M}_{13} {M}_{23} + j ω {M}_{12} {Z}_{3} )}{{ω}^{2} {M}_{23}^{2} + {Z}_{2} {Z}_{3}}$$

Furthermore, the voltage across each of these coils can be expressed in terms of the primary current and the relative impedances as:

$${V}_{1} = {I}_{1} ( \frac{( {Z}_{3} {ω}^{2} {M}_{12}^{2} - j 2 {ω}^{3} {M}_{23} {M}_{12} {M}_{13} + {Z}_{2} {ω}^{2} {M}_{13}^{2} )}{{ω}^{2} {M}_{23}^{2} + {Z}_{2} {Z}_{3}} + j ω {L}_{1} + {r}_{1} )$$

$${V}_{2} = \frac{{I}_{1} ( {Z}_{2} - j ω {L}_{2} ) ( {ω}^{2} {M}_{13} {M}_{23} + j ω {M}_{12} {Z}_{3} )}{{ω}^{2} {M}_{23}^{2} + {Z}_{2} {Z}_{3}}$$

$${V}_{3} = \frac{{I}_{1} ( {Z}_{3} - j ω {L}_{3} ) ( {ω}^{2} {M}_{12} {M}_{23} + j ω {M}_{13} {Z}_{2} )}{{ω}^{2} {M}_{23}^{2} + {Z}_{2} {Z}_{3}}$$

Here the reflected impedance seen at the primary pad is given by:

$${Z}_{r 1} = \frac{( {Z}_{3} {ω}^{2} {M}_{12}^{2} - j 2 {ω}^{3} {M}_{23} {M}_{12} {M}_{13} + {Z}_{2} {ω}^{2} {M}_{13}^{2} )}{{ω}^{2} {M}_{23}^{2} + {Z}_{2} {Z}_{3}}$$

### Ideal Series-Tuned Equations

Our work has shown that at large air gaps the inductance of the intermediate pad remains unaffected when moved over a certain vertical displacement. This means that it is possible to move the intermediate pad without mistuning it.

Therefore, under ideal conditions where all the loss resistances in the pads are considered small, and the intermediate circuit (i.e. pad) is perfectly tuned, then if intermediate pad resistance (r₃) is assumed to be approximately equal to zero, the impedance of the intermediate pad (Z₃) can be equated to zero.

Assuming the secondary pad is also ideally tuned in a series configuration, the impedance of the secondary side (Z₂) is equal to the equivalent AC load resistance (R_{load}) given r₂ is small compared to the load.

Under these ideal conditions, we propose that the above equations can be simplified as follows:

$$\frac{{I}_{3}}{{I}_{1}} = - \frac{{M}_{12}}{{M}_{23}} - j \frac{{M}_{13} {R}_{load}}{ω {M}_{23}^{2}}$$

$$\frac{{I}_{2}}{{I}_{1}} = - \frac{{M}_{13}}{{M}_{23}} = - \frac{{k}_{13}}{{k}_{23}} \sqrt{\frac{{L}_{1}}{{L}_{2}}}$$

$$\begin{matrix}{Z}_{r 1} = \frac{{M}_{13}^{2}}{{M}_{23}^{2}} {R}_{load} - j \frac{2 ω {M}_{12} {M}_{13}}{{M}_{23}} \\ = {( \frac{{k}_{13}}{{k}_{23}} )}^{2} \frac{{L}_{1}}{{L}_{2}} {R}_{load} - 2 j ω {L}_{1} \frac{{k}_{12} {k}_{13}}{{k}_{23}}\end{matrix}$$

The Equation for the ratio of I₃/I₁ shows the significance of the value of the load connected to a series tuned secondary. If the secondary load open circuits with no load R_{load} will equal infinity. Thus if the primary system is current sourced, such as is typical with an LCL tuned H bridge primary source which ideally produces a constant I₁ for a given bridge voltage, and if R_{load} tends to infinity, then this will cause the intermediate pad current and voltage to exponentially increase. Thus, any secondary load regulation circuit should ensure that load is not disconnected. A further observation is that if M₂₃ becomes small, this will have a similar effect independent of the load. This is one of the reasons why with a current sourced primary, the intermediate pad should be kept in proximity to the secondary (in the case of vehicle charging it could be attached to the vehicle). This will help constrain the volt-amps of the intermediate pad within reasonable voltage and current bounds, as M₂₃ remains relatively fixed, for the practical capacitors and chosen litz wire.

The equation for the I₂/I₁ ratio shows that the secondary current (I₂) depends on both the primary and secondary inductances (L₁) and (L₂) and the ratio of coupling ratios between the primary pad to the intermediate relative to the coupling between the intermediate to the secondary. It does not depend directly on the chosen value of the intermediate inductance (L₃). In existing light duty vehicle charging applications standards groups often place expectations on the size and design of the primary and secondary pads, and therefore, in these cases only the magnetic design of the intermediate pad has some freedom. The design (topology and size) and placement of such an intermediate pad should carefully consider the ratio of coupling k₁₃/k₂₃. This equation for I₂/I₁ also shows that if the primary is current sourced, then with a series tuned secondary, this load current is independent of the load, and acts as a constant current source. This is the reverse of the situation in a two-coil system.

The expression for Zᵣ₁ shows that the reflected impedance seen on the primary pad also does not depend on the value of the intermediate pad as it is simply a resonator with the sole purpose of extending the magnetic distance over which power can be transferred. However, care should be taken to do this appropriately without increasing leakage unnecessarily. Notably there is a capacitive impedance seen on the primary pad, however, at sufficiently large air gaps the coupling between primary and secondary pad (k₁₂) will be very small and thus this capacitive impedance will also be small, so that

$${Z}_{r 1} \approx {( \frac{{k}_{13}}{{k}_{23}} )}^{2} \frac{{L}_{1}}{{L}_{2}} {R}_{load} .$$

It should be noted that the simplified current equations assume that the intermediate pad is ideally tuned. However, in a practical system, the inductance of the intermediate pad will change when it is placed close to either the primary or secondary pad due to the proximity of the ferrite in the secondary and primary. Another factor which affects the simplified ratios, is the resistive losses in the intermediate coil and the reflected impedance seen on the intermediate coil. As the intermediate coil is moved closer to the primary pad, the reflected load from the secondary and seen by the intermediate pad becomes increasingly small and therefore r₃ becomes more significant. Therefore, under these conditions both the M₁₃/M₂₃ and I₂/I₁ ratios will begin to deviate from the simplified analysis, and the full equations need to be used.

However, assuming appropriate placement of the intermediate as a resonator, then using the above simplified expressions, the following assessment of volt-amps (VA) in the primary, secondary and intermediate coils can be derived for a series tuned secondary.

$${VA}_{1} = {I}_{1}^{2} ω {L}_{1}$$

$${VA}_{2} = {Q}_{2} P = {( \frac{{k}_{13}}{{k}_{23}} )}^{2} {VA}_{1}$$

$${VA}_{3} = {I}_{3}^{2} ω {L}_{3} = \frac{{V}_{r e c}^{2}}{ω {L}_{2} {k}_{23}^{2}} = \frac{{VA}_{2}}{{Q}_{2}^{2} {k}_{23}^{2}} = \frac{P}{{Q}_{2} {k}_{23}^{2}} = \frac{{P}^{2}}{{VA}_{2} {k}_{23}^{2}}$$

Here P represents being power transferred to the load

Often in commercial applications the VA in the secondary has to be constrained for thermal reasons, therefore there is a maximum Q₂ for a given P.

As shown, if k₂₃ is constrained (for example fixed or controlled to within a required range) by suitable placement and design of the intermediate coil, the Volt-amps in the intermediate (VA₃) is also naturally constrained and inversely proportionate to the Volt amps chosen in the secondary pad (VA₂) for a given power transfer. However, VA₂ cannot be increased unnecessarily given it also increases the demanded VA₁. For a chosen and fixed or constrained k₂₃, VA₂, VA₁ is impacted by k₁₃ and making this as large as possible without compromising k₂₃ is a matter of design based on expected movement and variation.

The above analysis has concentrated on systems using a current sourced primary and series tuned secondary.

However, if the primary is voltage sourced (where a voltage sourced inverter drives the primary pad inductance through a series capacitor) then the full design equations can also be analysed using the approaches discussed above. In this case it can be shown that the secondary has a voltage source coupled into it which is constant but dependent on the output inverter voltage (Vᵢₙᵥ) to the tuned primary circuit. This is very different from a two-coil tuned resonant system where the coupled voltage in the secondary is dependent on the primary current in the primary pad.

Consequently, such a voltage sourced primary three coil system:
if series tuned at the output and at a known coupling will have a constant voltage dependent on the primary inverter voltage driving the load, or
if parallel tuned at the secondary, will have a constant current dependent on the inverter voltage driving the load.

By way of example when it is series tuned at the output the following expressions can be derived.

$${I}_{3} = \frac{{V}_{i n v}}{ω {M}_{13}}$$

$${VA}_{3} = {I}_{3}^{2} ω {L}_{3} = \frac{1}{{k}_{13}^{2}} \frac{{V}_{i n v}^{2}}{ω {L}_{1}} = \frac{{VA}_{1}}{{Q}_{1}^{2} {k}_{13}^{2}}$$

$${V}_{OC \_ 23} = \frac{{M}_{23}}{{M}_{13}} {V}_{i n v}$$

Here Voc_23 is the open circuit voltage at the secondary pad, and is shown to be constant, and dependent on the ratio of the magnetic coupling between the coils for a given primary inverter voltage. The same expression of open circuit voltage exists for both series tuned or parallel tuned secondary coil.

Both the current and volt-amps in the intermediate is controlled providing k₁₃ is managed for a given inverter voltage. This implies that it is better to fix or control any variation of the intermediate relative to the primary coil when the source is voltage controlled. If k₁₃ was to get too small (e.g. If the intermediate coil was fixed to a moving vehicle), there is significant danger that the intermediate coil VA would cause the voltages and currents to exceed the design requirements and cause failure.

Using all of the above analysis, it is clear that for applications where the intermediate is part of the vehicle, the primary should ideally be current driven or vehicle movement must be constrained, whereas for applications where the intermediate is fixed in relation to the primary, the primary should be voltage driven. In this case the system can be designed, and suitable power regulation controllers can be considered.

### Validation Simulation for a Three-Coil System

For IPT pads to be used commercially and be fitted into private electric vehicles (EVs), the designed magnetic pads in the power range up to 11 kW need to adhere to the SAE J2954 and the ICNRIP guidelines for stationary charging. Sizing of magnetic pads for trucks or vehicles at higher power levels or with high air gaps have not yet been considered, therefore to validate the above ideas, circular pads sized identical to that given in SAEJ2954 for WPT3 power class for their largest distance class were used. These sized circular pads were used for the primary and secondary pads and are rated for 10 kW power transfer to the vehicle with a ground clearance of 250 mm. These are also be used as a basis for comparison against a design with an intermediate coupler.

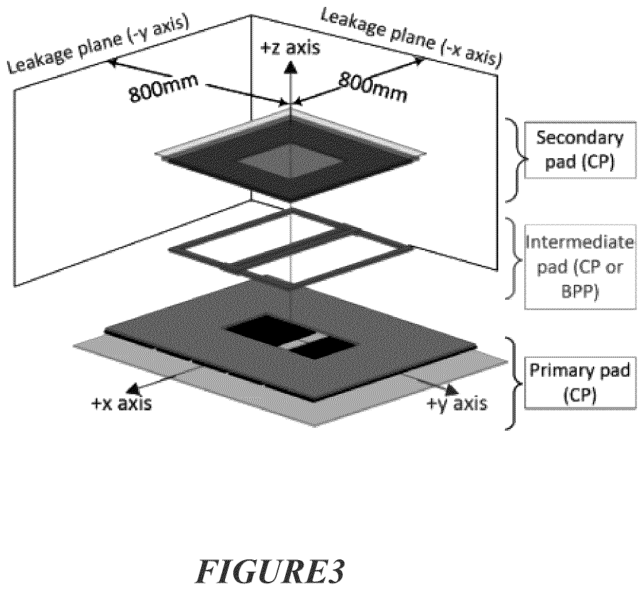

To validate the idea that an intermediate coil can be designed to safely operate under either secondary or primary control or both, with reduced leakage in areas where humans may be present (as measured at the 800 mm planes from the secondary), several existing magnetic pad structures were chosen to be used along with an intermediate pad to increase the power transfer distance. Either a single or multi-coil intermediate structure could be used for this purpose as shown in FIG. 3.

To validate the chosen three-coil system, it is then compared to the effort required by well-designed two coil pads transferring 10 kW power over a 411 mm air gap.

Notable from the developed expressions, is that when dealing with a series tuned secondary it is helpful to have the intermediate pad either locked in relation to the secondary pad or in sufficient close proximity whenever power transfer is considered in order to fix or constrain M₂₃. This is to ensure that the intermediate pad always sees a suitable reflected load, because as noted if the secondary becomes open circuited or not in the vicinity of the intermediate then the current in the intermediate (I₃) will rise significantly.

### Primary VA Effort

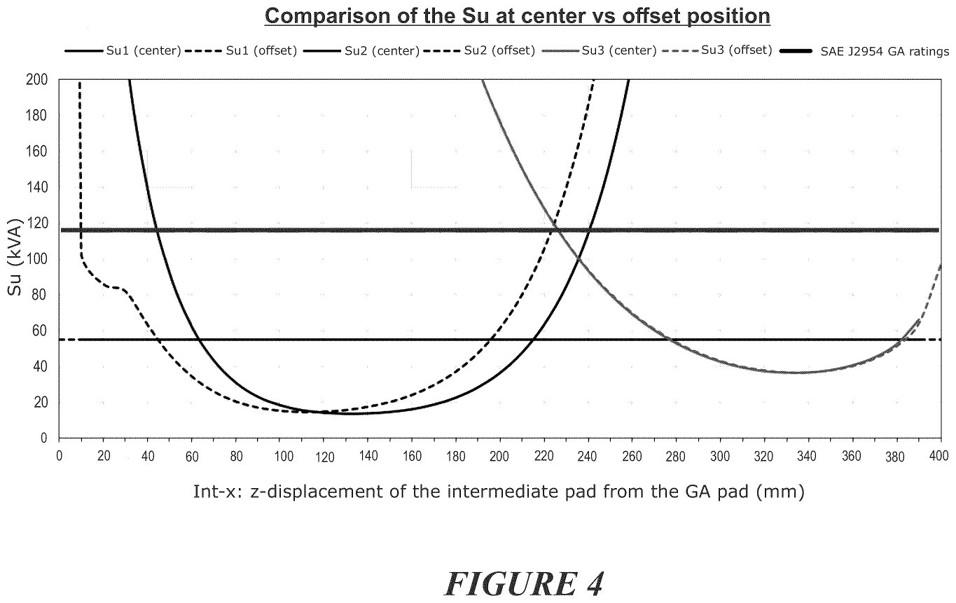

In the SAE J2954 recommended practice, a universal primary pad is used to test a variety of different vehicles secondary pads. The effort required by the primary pad changes depending on the vehicle ground clearance and the power requirement of the vehicle. According to this recommended practice, the inductance of the primary pad can change between 29.6 uH to 35.8 uH and the maximum current through the primary pad is 75 Aᵣₘₛ. This corresponds to a maximum VA (Sᵤ) rating of approximately 126 kVA across the primary pad when delivering 10 kW to the secondary load i.e. car battery. This value is shown in FIG. 4 to compare the VA effort of the three-coil system. In this simulation, the distance and coupling (k₁₂) between the primary and secondary pad is approximately 410 mm and 0.027 respectively. Since, the intermediate has no ferrite therefore, moving the intermediate has negligible effect on the inductance of the primary and secondary pad.

To determine suitable positions to the place an intermediate resonator, different vertical heights i.e. z-displacements for the intermediate pad were investigated relative to the primary when the intermediate and secondary were either centered or offset laterally by (x,y)=(75,100) mm. FIG. 4 shows the apparent power across the different pads at centred and offset positions. To increase the overall efficiency (using the lowest collective VA effort), the intermediate pad should be placed slightly closer to the primary pad than the secondary.

### Evaluation of Expected Leakage Fields

For the IPT pads to be commercially used, they need to adhere to the ICNRIP guidelines which states that the magnetic flux density should be lower than 27 μT rms when operating at a frequency of 85 kHz. Leakage fields are measured 800 mm away from the centre of the secondary pad, since, the width of a typical small car is approximately 1600 mm.

Magnetic simulations were performed on “Ansys Maxwell” to determine the leakage fields. These simulations were done while maintaining a constant output power of 10 kW. The size of the primary pad was taken as identical to that of the universal pad, while the size of the secondary was that of a WPT3 pad. The intermediate was sized to be the same as the secondary. The maximum value of the magnetic flux density was recorded in the different axis when the pads were centred and offset.

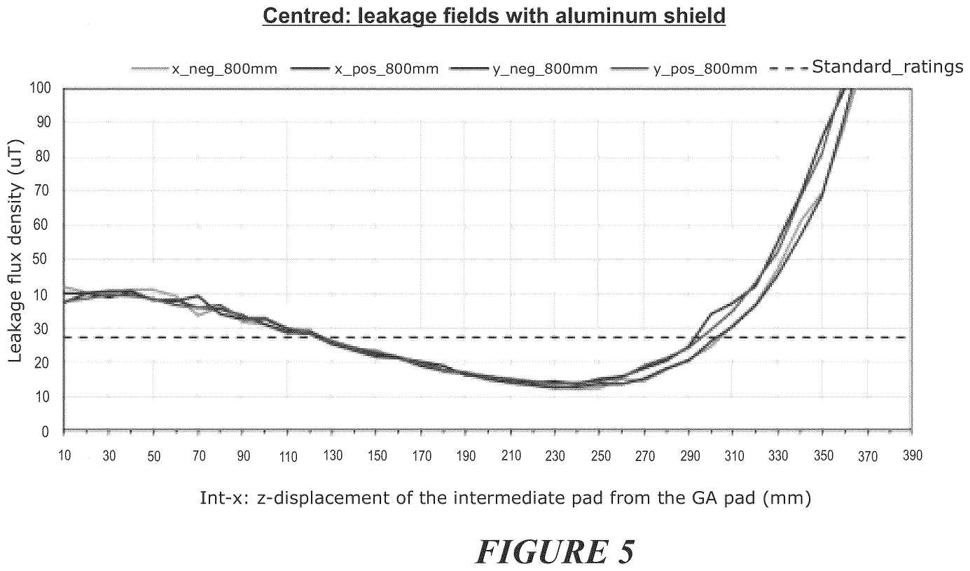

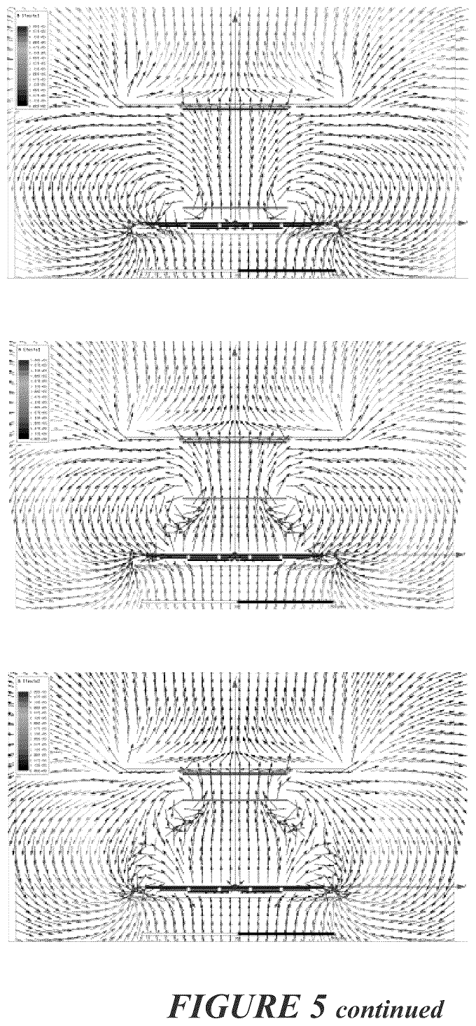

When the pads are centred, the leakage fields are similar in all axes. FIG. 5 shows that when the intermediate is closer to the primary pad, the magnetic field lines are forced to go through the intermediate pad. This helps reduce the leakage fields. Also, because the intermediate pad is smaller than the primary pad, it helps reduce the leakage fields return path. For example, if the intermediate pad was same size as the primary pad, the main magnetic flux will flow through the centre of intermediate and the return magnetic flux will be pushed outwards resulting in increase in leakage fields. However, as the z-displacement increases i.e. the intermediate pad moves further away from the primary pad, not all the magnetic flux from primary pad passes through the intermediate and instead it returns to the primary pad and contributes towards the leakage fields.

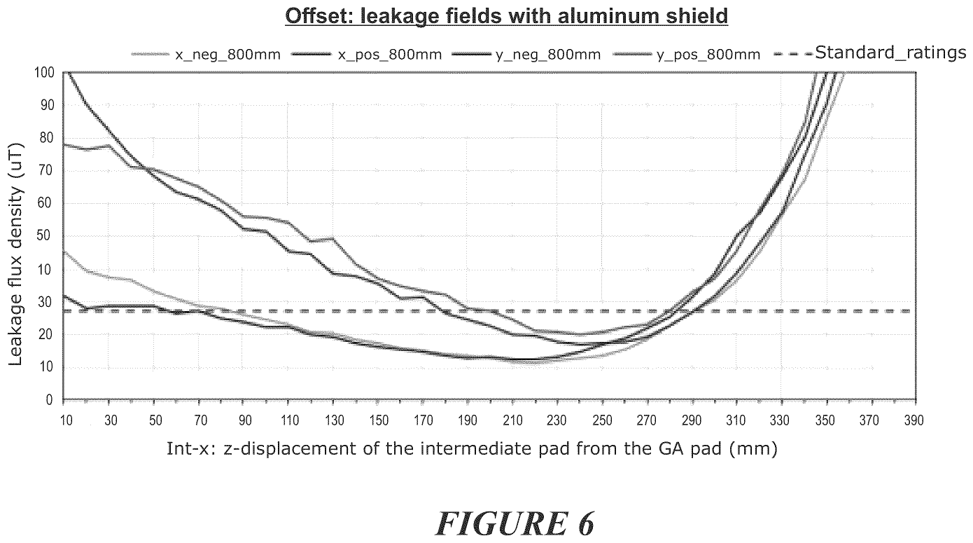

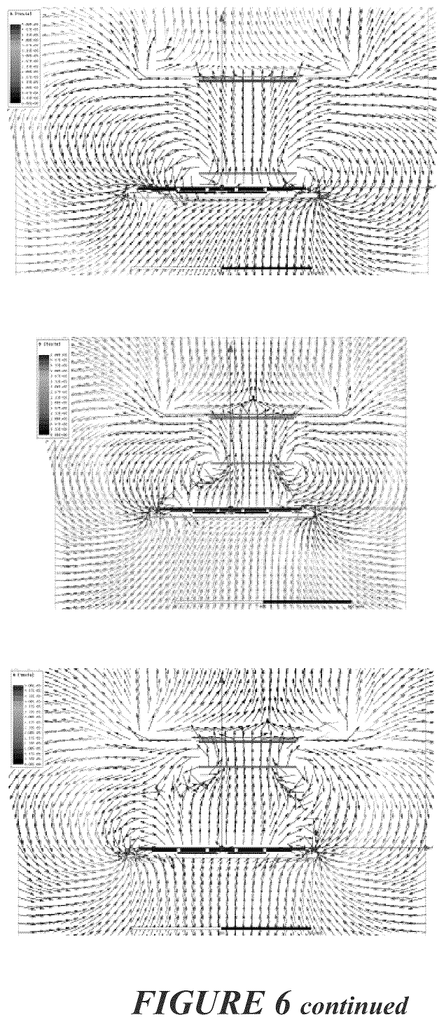

However, when the secondary and intermediate pads are offset together in the positive x and y-axis, the simulations in FIG. 6, show that higher leakage fields appear in the positive axis compared to negative axis. Similarly to before, the main magnetic flux passes through the centre of the intermediate pad while the return magnetic flux pushed away from the centre. This causes an increase in the leakage fields in the positive axis, while, in the negative axis the return leakage fields get attracted to the ferrite in the primary pad resulting in a reduction in the leakage field.

### Increasing the Intermediate Size.

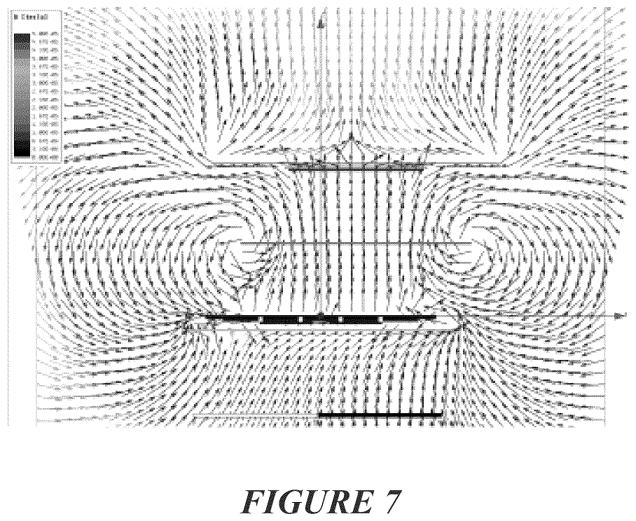

FIG. 7 shows the field leakages with the intermediate placed at a Z-disp of 200 mm, using Outer dimensions for the Intermediate pad identical to the size of the primary. All currents and their phases are identical to that in FIG. 6.

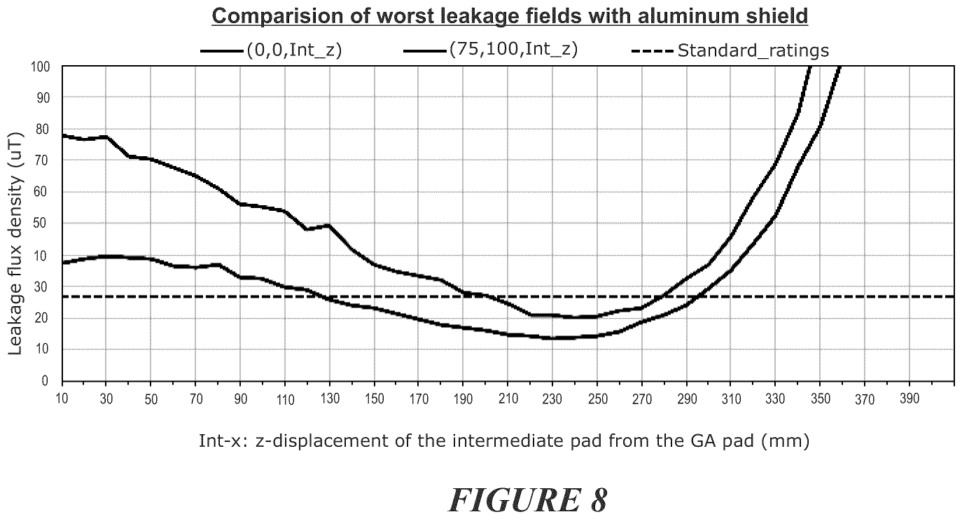

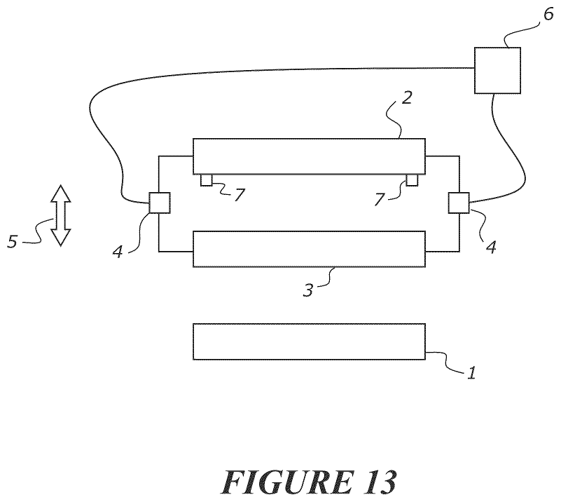

FIG. 8 shows the comparison of the leakage fields in the positive y-axis with the above pad sizings are centred and offset. When the pads are centered simulations show that the leakage fields meet the 27 uT rating when the z-displacement of the intermediate pad is between 130 mm to 290 mm. However, to meet the 27 uT requirement during the offset position, the z-displacement of the intermediate pad needs to be between 210 mm to 280 mm. This shows the it is possible to meet the leakage requirement with an intermediate pad when the air gap is large. Having a moving mechanism would be useful on a vehicle as it can help maintain lower leakage fields and lower the effort required. This could be a mechanism configured to simply lower the complete secondary pad or construct a light-weight intermediate coil structure which can be placed in between the primary and the secondary pad. This may require having external sensors for detection of best positions, and would need a motor to move the intermediate pad and will add cost to the vehicle. However it has the advantage of allowing a light-weight ferrite-less structure that includes only the copper coil and a resonant capacitor to be lowered without any physical wiring. The lower weight means low-cost motors can be used, and in case of damage or theft, it is cheaper to replace. As another alternative, where possible an intermediate coil can be fixed to the chassis. FIG. 13 which is discussed further below assists in illustrating some to these options.

Comparison of a Three-Coil System with Possible Two-Coil Systems

Previous comparative analyses between having a two-coil system or a three-coil system have analysed the power transfer efficiency between the two coil and three-coil systems. However, none have compared the magnetic leakage in the presence of an intermediate resonant coil at high power or have considered regulation on the secondary side. We have been able to show that the presence of the extra current carrying windings can help boost the efficiency of the primary coplanar system. Therefore, to determine how much impact the extra copper from the intermediate pad can have on the leakage fields, three different two coil equivalent cases were investigated for comparison as follows:
Case 1: The original standard Universal Ground Assembly pad (GA_Coil) and largest sized WPT3 Vehicle Assembly Pad (VA_Coil) were used for the primary and secondary pad but separated 400 mm, and operated in such a way to transfer the required volt-amps to the secondary at rated power. This helps to show both the expected volt-amp effort and the relative impact on leakage fields without an intermediate pad present.
Case 2: The primary and secondary pad were made identical to the UGA primary pad design. Assuming the ground side pad cannot be increased, then this represents a best-case scenario for a two-coil system to improve the coupling factor (k₁₂). Notably, having a large secondary pad results in higher cost and weight to the vehicle, whereas vehicle manufacturers prefer the secondary pad to be as small and light as possible.
Case 3: The volume of extra copper determined to be in the intermediate pad was added to the secondary pad, and the ferrite and the aluminium of the new VA_Coil was also increased by the same ratio as the copper increase.

Another case was also considered where the volume of copper of the intermediate pad was added onto the primary pad. However, given the primary pad is already 2.5 times bigger than the secondary, this had little impact.

The exact dimensions of the pads are listed in Table 1.

TABLE 1
Dimensions of comparative two coil systems

| | Case | | |
|---|---|---|---|
| | | Case 2 | Case 3 |
| | Case 1 | (Both pads same | (VA pad volume |
| | (standard pads) | size as GA) | increased) |
| GA outer | 650 × 500 × 5 | 650 × 500 × 5 | 650 × 500 × 5 |
| coil | | | |
| dimensions | | | |
| (mm) | | | |
| GA outer | 508 × 650 × 5 | 508 × 650 × 5 | 508 × 650 × 5 |
| ferrite | | | |
| dimensions | | | |
| (mm) | | | |
| VA outer | 380 × 380 × 5 | 650 × 500 × 5 | 434 × 434 × 5 |
| coil | | | |
| dimensions | | | |
| (mm) | | | |
| VA outer | 400 × 400 × 5 | 508 × 650 × 5 | 444 × 444 × 5 |
| ferrite | | | |
| dimensions | | | |
| (mm) | | | |
| GA turns | 8 (bi-filar) | 8 (bi-filar) | 8 (bi-filar) |
| VA turns | 8 | 8 (bi-filar) | 10 |

### Effort Required by Primary Pad

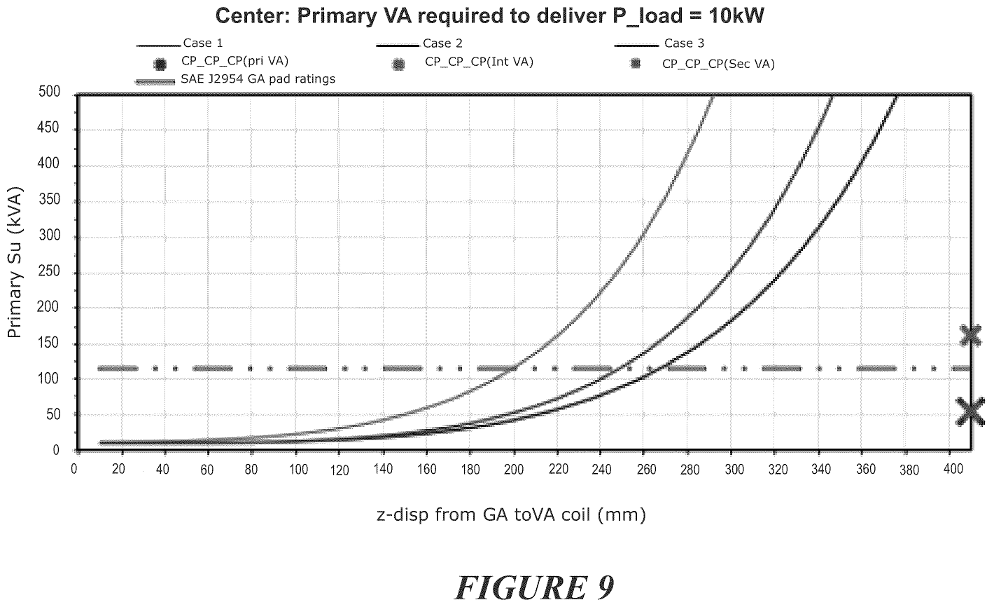

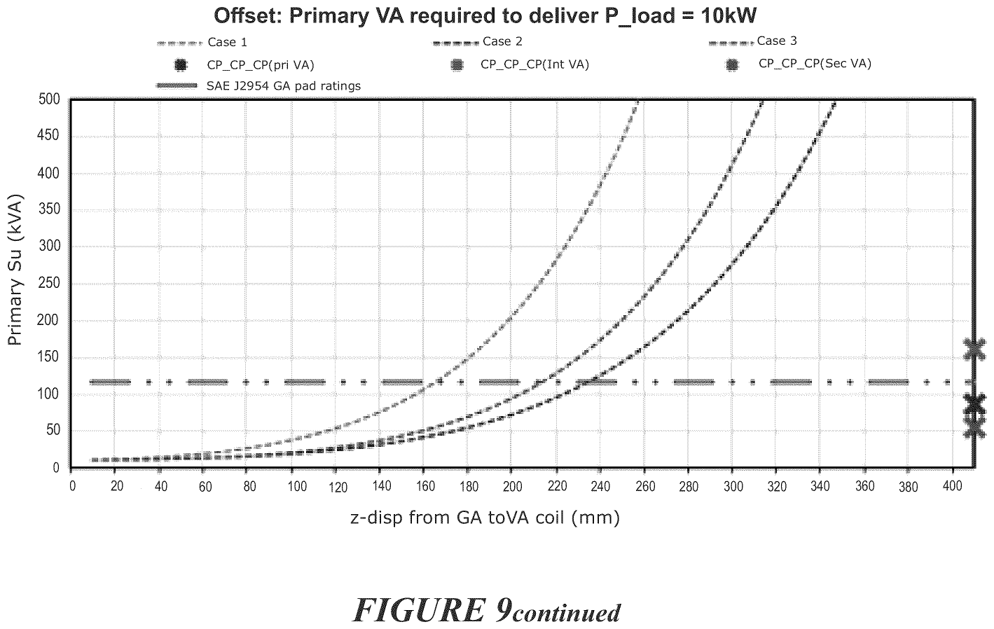

FIG. 9 shows the simulation results of the primary volt-amp effort required to transfer 10 kW to the secondary pad (VA_Coil). The solid and dashed lines in the figures represent when the pads are centred and offset respectively. The crosses at the end of the graph represent the expected volt-amps across the three-coil system using an intermediate pad, with the air gap between primary and secondary pad being 410 mm and the distance between the primary and intermediate pad being 220 mm. The purple dashed line represents the rated 116 kVA design of the pads in the J2954 recommended practice. This 116 kVA apparent power can be used to determine the relative impact of extending the air gap in each of the 3 cases against the three-coil system.

Case 1 shows that the original design is only expected to operate with an air gap of up to 200 mm when centred or 170 mm when offset.

Case 2 produces the best results, enabling air gap to be extended to 270 mm when centred and 240 mm when offset while maintaining a 116 kVA rating across the primary pad.

Case 3 shows significant improvements over case 1 but allow only an extended air gap to 250 mm when centred and 210 mm when offset.

Notably, none of the three cases using two coils can maintain the rated 116 kVA for the primary pad when the air gap between the primary and secondary pad is 410 mm. Meanwhile, at an air gap of 410 mm with an intermediate pad, the effort required by the primary pad can be lowered to 55.1 kVA and 86.8 kVA when centred and offset respectively. This shows that an existing standard pad and power supply could be used to supply 10 kW to the vehicle at twice the air gap.

Lowering the primary volt-amps and increasing the air gap does mean that the intermediate pad needs to exert higher volt-amps (161.9 kVA when centred and 161.5 kVA when offset). Since, the intermediate does not have any active components, the power loss in the intermediate coil is dependent on the resistive losses of the intermediate pad and the tuning capacitors. As the output power is independent of intermediate inductance, then there is the ability to increase the number of turns to lower the current (I₁) which will also reduce power loss, however, it will increase V₃ across the intermediate tuning capacitors (C₃), so care is required. In all cases managing the Volt-amp rating of the intermediate is desirable.

### Leakage Fields

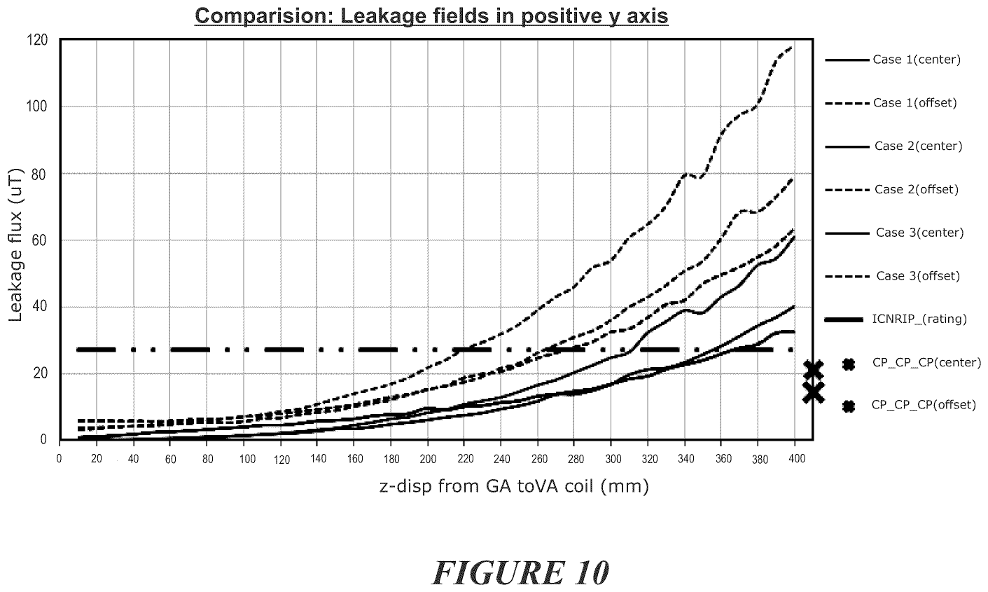

FIG. 10 shows the leakage fields for the different cases when the pads are centred and offset. The legends are same as the previous graphs. Similar to before, case 2 shows the best possible option to lower the leakage fields. When centred, case 1, 2 and 3 can maintain 27 uT leakage fields at air gaps of 310 mm, 360 mm and 380 mm respectively. Whereas, when offset case 1, 2 and 3 can maintain 27 uT leakage fields at air gaps of 220 mm, 270 mm and 280 mm respectively. At centred positions, case 2 and 3 show that it can maintain the rated leakage fields however none of these cases meet the required 27 uT at 410 mm when centred or offset. On the other hand, the intermediate pads, can maintain leakage fields up to 14 uT when centred and 21 uT when offset.

### Summary of Control Options

With any tuned resonant circuits, having the correct type of control technique is highly desirable. For example, with a series tuned secondary, which acts as a voltage source, an open-circuit control method is appropriate such as a buck converter.

### Current Sourced Primaries:

A current sourced primary produces a voltage sourced intermediate, which in turn produces a current sourced secondary coil (assuming ideal tuning) into the secondary coil to drive the secondary tuning network and load. This secondary tuning network should ideally be series tuned before any further compensation or regulation. Power regulation requires the impedance to the series tuned secondary to be able to produce a short circuit rather than an open circuit.

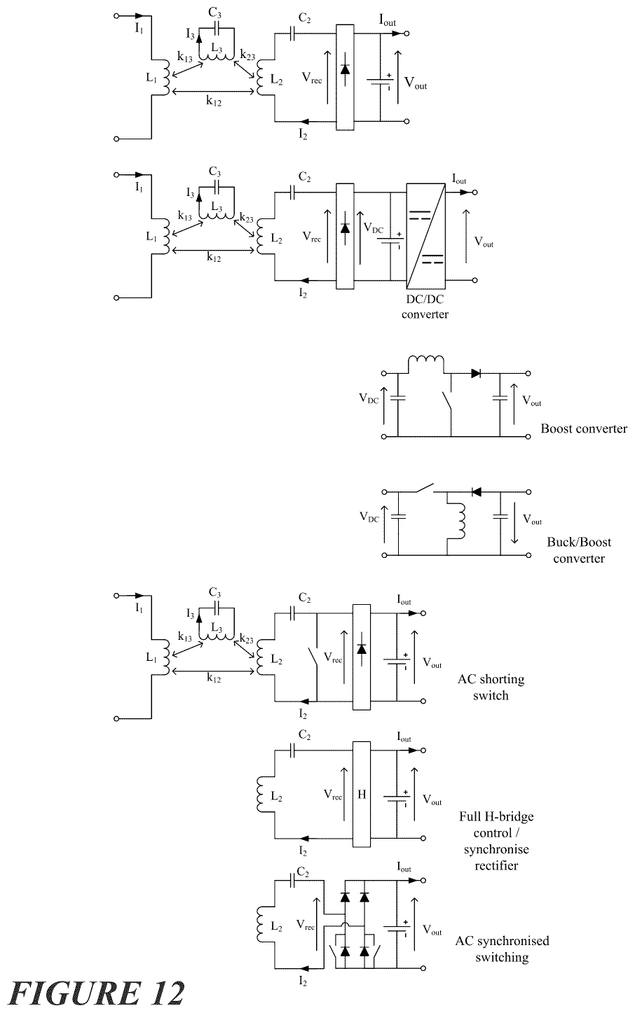

Suitable secondary regulators that could be applied directly to the output of such a series tuned secondary include, an H bridge or a voltage doubler, a diode rectifier with capacitor output followed by either a Boost or Buck Boost, or Cuk regulator. Examples of these are shown in the schematic FIG. 12 below. Because the primary is current sourced, care should be taken to ensure the output does not become open circuit, and the switches short circuit the tuning network under regulation.

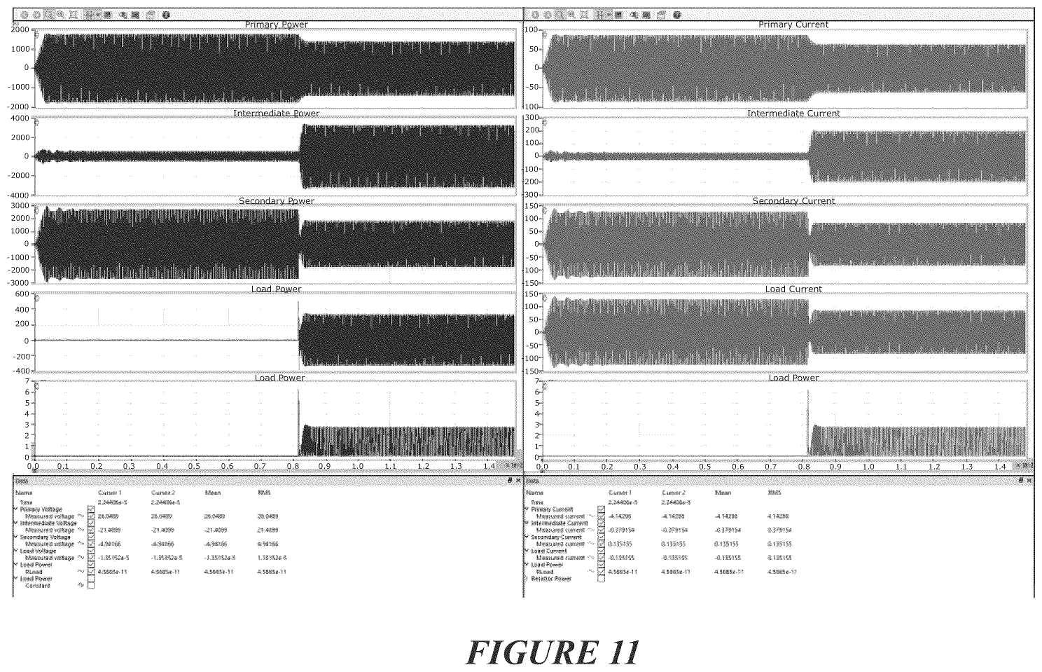

A PLECS simulation using an LCL (current sourced) primary with intermediate and series tuned secondary and a boost controller to regulate the output load is shown in FIG. 11. The results validate that the expected control is possible. Here the vehicle coil, L₂, with its tuning capacitor, C₂, is shorted so that the effective rectifier voltage V_{rec} and the DC output V_{dc} becomes zero causing VA₃ in the intermediate coil to collapse.

As noted earlier, if the intermediate is maintained in a controlled position relative to the secondary, then power regulation is achievable with a current sourced primary and the Volt amps are also controlled along with the field emissions. As noted earlier, if the intermediate is maintained in a controlled position relative to the secondary and with the power regulation circuitry present on both the primary and secondary side, the Volt amp of all three coils, primary, intermediate and secondary coils, can be controlled along with the field emissions while performing output power regulation. FIG. 13 shows a diagrammatic example of a system for controlling the position of the intermediate 3 relative to the secondary 2. An actuation means such as one or more motors or linear actuators 4 for example are driven by a controller 6 to adjust the separation between the intermediate 3 and the secondary 2 as required. The separation can be adjusted over a range as indicated by arrows 5. The controller may act to make the adjustments dependent on the output of one or more sensors 7. The sensors 7 may detect electrical and/or magnetic parameters of the circuits or coils, and/or detect leakage fields. In some embodiments the sensors may detect the physical proximity of the magnetic structures. It will be seen that the arrangement shown in FIG. 13 may be extended to the primary. For example, the actuators 4 may alternatively or additionally be located between the primary 1 and the intermediate 3 so that the position of the intermediate 3 relative to the primary 1 can be controlled.

If the intermediate is not maintained in a controlled position relative to the secondary (e.g. it is maintained in a controlled position relative to the primary) then the intermediate VA can rise sharply with lower coupling between the intermediate and the secondary.

A parallel tuned secondary can also be used for a current sourced primary but its behaviour to the load is neither a current or voltage source, and therefore it does not allow simple control of the intermediate Volt-Amps, and therefore more care is required in the design.

### Voltage Sourced Primaries

A voltage sourced primary (using a voltage sourced inverter and series tuned primary coil) produces a current sourced intermediate and this produces a voltage source to drive the secondary coil and its tuning network and load. As such, in the case of a voltage-sourced primary, either parallel or series tuning configurations can be used. A series tuned output will result in an effective voltage source to the rectifier or H bridge, whereas a parallel tuned circuit will result in an effective current source to the rectifier, however as opposed to a two-coil system, these sources are dependent on the primary inverter voltage not the primary coil current. All traditional secondary regulators can be used as for series or parallel tuned secondaries in two-coil systems, and LCL networks can also be used enabling control of the intermediate. In this case the intermediate should be placed in proximity to the primary not the secondary to ensure its volt amps can be managed, and the field emissions are also suitable.

In connection with a series-tuned primary, it is worthwhile noting that the secondary control circuit can regulate the VA in the secondary coil and consequently adjusting the inverter voltage accordingly. This adjust on the inverter voltage then regulates the VA in the intermediate coil.

The whole control action can still start from the secondary side regulator which dictates the primary inverter voltage which then regulates the intermediate coil VA.

The control of the VA described also provides a method leakage field control for an IPT system having an intermediate coupling structure, the method comprising regulating a secondary to thereby regulate leakage field from the intermediate coupling structure.

Therefore, the method for controlling leakage field from the intermediate coupling structure includes controlling the VA in the intermediate coupling structure.

1-31. (canceled)

32. An IPT system comprising:
an intermediate circuit of a first source type adapted to be coupled to a primary circuit of a second source type; and
a secondary circuit of either source type coupled to the intermediate circuit and adapted to be coupled to the primary circuit;
wherein the first and second source types are different ones of current-sourced and voltage-sourced.

33. The IPT system of claim 32, wherein the first and second source types are respectively voltage-sourced and current-sourced, and the secondary circuit comprises:
a secondary coupler providing a coupler voltage, and
a secondary parallel tuning network connected to the secondary coupler and providing from the coupler voltage a voltage source.

34. The IPT system of claim 33, wherein the secondary circuit further comprises:
a regulator connected directly to the parallel tuning network and producing an open circuit thereacross.

35. The IPT system of claim 32, wherein the first and second source types are respectively voltage-sourced and current-sourced, and the secondary circuit comprises:
a secondary coupler providing a coupler voltage, and
a secondary series tuning network connected to the secondary coupler and providing from the coupler voltage a current source.

36. The IPT system of claim 35, wherein the secondary circuit further comprises:
a regulator connected directly to the secondary series tuning network and producing a short circuit thereacross.

37. The IPT system of claim 36, the regulator includes at least one of:
an H bridge;
a voltage doubler;
a diode rectifier;
an active rectifier;
a rectifier and capacitor; and
a rectifier and capacitor followed by one or more of a boost, buck-boost or cuk regulator.

38. The IPT system claim 33, wherein the intermediate circuit has a position controllable relative to the secondary circuit.

39. The IPT system of claim 38, wherein the intermediate circuit is adapted to be arranged proximate to the secondary circuit relative to the primary circuit.

40. The IPT system of claim 32, wherein the first and second source types are respectively voltage-sourced and current-sourced, and the secondary circuit comprises:
a secondary coupler providing a coupler voltage, and
a secondary tuning network connected to the secondary coupler and providing from the coupler voltage a voltage source, the secondary tuning network comprising at least three components including at least one inductor and at least one capacitor.

41. The IPT system of claim 32, wherein the first and second source types are respectively current-sourced and voltage-sourced, and the secondary circuit further comprises:
a secondary coupler providing a coupler voltage, and
a secondary series tuning network connected to the secondary coupler and providing from the coupler voltage a voltage source.

42. The IPT system of claim 41, wherein the IPT system further comprises:
a regulator connected directly to the secondary series tuning network and producing an open circuit thereacross.

43. The IPT system of claim 32, wherein the first and second source types are respectively current-sourced and voltage-sourced, and the secondary circuit further comprises:
a secondary coupler providing a coupler voltage, and
a secondary parallel tuning network connected to the secondary coupler and providing from the coupler voltage a current source.

44. The IPT system of claim 43, wherein the IPT system further comprises:
a regulator connected directly to the secondary series tuning network and producing a short circuit thereacross.

45. The IPT system of claim 41, wherein the intermediate circuit has a position controllable relative to the primary circuit.

46. The IPT system of claim 45, wherein the intermediate circuit is adapted to be arranged proximate to the primary circuit relative to the secondary circuit.

47. The IPT system of claim 32, wherein the first and second source types are respectively current-sourced and voltage-sourced, and the secondary circuit comprises:
a secondary coupler providing a coupler voltage, and
a secondary tuning network connected to the secondary coupler and providing from the coupler voltage a current source, the secondary tuning network comprising at least three components including at least one inductor and at least one capacitor.

48. The IPT system of claim 32, wherein the intermediate circuit is adapted to be coupled directly to the primary circuit and is coupled directly to the secondary circuit.

49. The IPT system of claim 32, further comprising:
the primary circuit.

50. The IPT system of claim 49, wherein the primary circuit comprises an inverter, a compensation network and a primary coupler.

51. The IPT system of claim 35, wherein the intermediate circuit has a position controllable relative to the secondary circuit.

52. The IPT system of claim 43, wherein the intermediate circuit has a position controllable relative to the primary circuit.
